(19) United States
(12) Patent Application Publication
(10) Pub. No.: US 2011/0067509 A1
(43) Pub. Date: Mar. 24, 2011

(54) Compensation of Rotational Shaft Inclination

(75) Inventors: Albrecht Kleibl, Grosshennersdorf (DE); Christian Heichel, Niedernberg (DE)

(73) Assignee: ABI Anlagentechnik-Baumaschinen-Industriebedarf Maschinenfabrik und Vertriebsgesellschaft mbH, Niedernberg (DE)

(21) Appl. No.: 12/596,805

(22) PCT Filed: Apr. 16, 2008
(86) PCT No.: PCT/EP08/03038

§ 371 Date: Dec. 6, 2010

(30) Foreign Application Priority Data
Apr. 20, 2007 (DE) 10 2007 018 794.9

(51) Int. Cl. B06B 1/16; F16C 33/04; B06B 1/10

(52) U.S. Cl. 74/61; 384/125; 74/25

(57) ABSTRACT

Bearing arrangement for a rotatable shaft comprising an inner bearing part for coupling to an end of the shaft, an outer bearing part for coupling to a mounting structure, and an axis of rotation, wherein at least one of the inner bearing part and the outer bearing part, at least in certain areas, possesses elastic deformability, at least in part, perpendicular to the axis of rotation, and an arrangement comprising the bearing arrangement and a shaft, as well as an oscillator comprising the latter.

### FIELD OF THE INVENTION

The present invention relates, in general, to means for mounting rotatable shafts and, in particular, to bearing arrangements for compensating rotational shaft deformation or shaft deflection occurring in rotating shafts.

### BACKGROUND OF THE INVENTION

In rotatable and, in particular, rotary driven shafts, deformations and, in particular, shaft deflections may occur during operation (i.e. when rotating the shaft), if there are forces not acting in parallel with (e.g. perpendicular to or at an angle to) the longitudinal axis of the shaft.

The following cases may be distinguished, namely cases in which the direction of forces not acting in parallel with the longitudinal axis of the shaft remains substantially the same, and cases in which the direction of forces not acting in parallel with the longitudinal axis of the shaft changes and, in particular, rotational radial forces occur.

In the first case, a substantially stationary shaft deformation or shaft deflection occurs. This may be referred to as rotational deformation or rotational deflection (or bending).

In the second case, a shaft deformation or shaft deflection occurs, the characteristic or direction of which changes as a function of the change in direction of the underlying forces. This is the case, in particular, with rotational radial forces. This may then be referred to—following the term “rotational radial forces”—as rotational shaft deformation or shaft deflection.

Examples of the first case include paper machines and rope winches, wherein the direction of forces not acting in parallel with the longitudinal axis of the shaft does not change (e.g. forces due to cooperating paper rollers arranged on shafts; forces acting on a rope arranged on a rope winch).

Examples of the second case include oscillators and vibrators, wherein unbalanced masses are provided on shafts which are rotated together with the shaft thereby generating rotational radially acting forces with respect to the longitudinal axis of the shaft or axis of rotation.

For compensation of rotational deformation or rotational deflection (or bending) in the first case, it is known, for example, to provide the radially outward part of a shaft bearing (e.g. an outer roller bearing ring) with a hinge bearing providing a hinged connection, for example, to a housing. However, such approaches are not suitable or only suitable to a limited degree for providing for compensation in the second case (rotational shaft deformation or shaft deflection).

### OBJECT OF THE INVENTION

It is the object of the present invention to provide solutions for compensating rotational shaft deformations or shaft deflections occurring in rotatable shafts.

### BRIEF DESCRIPTION OF THE INVENTION

For solving the above object, the present invention provides a bearing arrangement, an arrangement comprising the bearing arrangement and a shaft, as well as an oscillator according to the independent claims.

The bearing arrangement according to the invention is intended for a rotatable shaft and comprises an inner bearing part for coupling to an end of the shaft, an outer bearing part for coupling to a mounting structure, and an axis of rotation. At least one of the inner bearing part and outer bearing part, at least in certain areas, possesses elastic deformability, at least in part, perpendicular to the axis of rotation.

The terms “inner” and “outer” used for the bearing parts have been chosen for indicating that an inner bearing part is arranged at a lesser distance from the axis of rotation in the radial direction with respect to the axis of rotation than the corresponding outer bearing part.

The term “coupling” and wordings comparable thereto, such as “coupled”, encompass that two components are immediately and directly connected to each other, for example, by means of one or a plurality of screw, clamp, adhesive, welded connections and/or positive and/or non-positive connections. However, the term “coupling” and wordings comparable thereto, such as “coupled”, also encompass that two components are indirectly connected to each other, for example, by means of an intermediate connecting element and/or structure.

In comparison thereto, the term “connection” and wordings comparable thereto, such as “connected”, are supposed to indicate that two components are immediately and directly connected to each other, e.g. as explained above by way of example.

In the case of the inner bearing part, coupling to the end of the shaft may be implemented, for example, by connecting the inner bearing part and the shaft end positively and/or non-positively to each other or by using a connecting structure between the inner bearing part and the shaft end (e.g. a bearing receiving means for the inner bearing part connected to the shaft end; a shaft receiving means for the shaft end connected to the inner bearing part).

Although it is referred to a use of the bearing arrangement according to the invention in oscillators and vibrators in the following and, in particular, in the description of preferred embodiments, it should be noted that the bearing arrangement according to the invention may be used wherever rotational shaft deformations and/or shaft deflections are to be compensated.

The inner bearing part preferably comprises a bearing sleeve for a plain bearing.

It is further preferred that the outer bearing part comprises a bearing bush for a plain bearing.

The inner bearing part may comprise a region which is adapted for torsion-resistant operative connection and, in particular, for positive reception of the end of the shaft.

In preferred embodiments, at least one of the inner bearing part and the outer bearing part is, at least in part, elastically compressible.

In further preferred embodiments, the inner bearing part comprises a first region having a first inner diameter and being, at least in part, elastically deformable and a second region having a second inner diameter, wherein the first inner diameter is greater than the second inner diameter. In such embodiments, it may be contemplated that the second region is adapted for torsion-resistant coupling to the end of the shaft, whereas the first region, when the shaft and the second region are coupled to each other in use, is not in contact with the shaft, in particular, with the end of the shaft, but is detached and capable of being deformed due to its partial elastic deformability and of compensating rotational shaft deformations and/or shaft deflections. The second region may also be elastically deformable.

The first region of the inner bearing part preferably has the form of an elastically deformable hollow cylinder.

Moreover, the inner bearing part may comprise at least one bearing surface for operative connection with the outer bearing part.

The at least one bearing surface of the inner bearing part may be coated, at least in part, with a plain bearing material and/or may be composed, at least in part, of such a material.

Furthermore, the at least one bearing surface of the inner bearing part may be arranged substantially concentrically with the axis of rotation and/or substantially perpendicular to the axis of rotation. In the first case, the at least one bearing surface of the inner bearing part may be formed at an outer circumferential surface being concentric with the axis of rotation. In the second case, the at least one bearing surface of the inner bearing part may be formed at a region extending substantially perpendicular to the axis of rotation, wherein it is further possible that the region of the inner bearing part extending substantially perpendicular to the axis of rotation is adapted for operative connection with a shoulder formed on the shaft.

The outer bearing part may (also) comprise at least one bearing surface for operative connection with the inner bearing part and/or the shaft, which is preferably coated, at least in part, with a plain bearing material and/or is composed, at least in part, of such a material.

The at least one bearing surface of the outer bearing part may be arranged substantially concentrically with the axis of rotation and/or substantially perpendicular to the axis of rotation. In the first case, the at least one bearing surface of the outer bearing part may be formed at an inner circumferential surface being concentric with the axis of rotation. In the second case, the at least one bearing surface of the outer bearing part may be formed at a region extending substantially perpendicular to the axis of rotation, wherein it is further possible that the region of the outer bearing part extending substantially perpendicular to the axis of rotation is adapted for operative connection with the region of the inner bearing part extending substantially perpendicular to the axis of rotation.

In preferred embodiments, the outer bearing part comprises a region including both, a bearing surface for operative connection with the inner bearing part and a mounting surface which is adapted for fastening the outer bearing part to a mounting structure. For example, a housing of the bearing arrangement may serve as the mounting structure. In such embodiments, elastic deformability of the outer bearing part may be achieved, for example, by use of an elastically compressible material.

In further preferred embodiments, the outer bearing part comprises a first region for operative connection with the inner bearing part and an elastically deformable second region coupled to the first region. It is contemplated that the second region is not in direct contact with the inner bearing part, but is indirectly coupled thereto via the first region. This separation enables the second region to compensate rotational shaft deformations and/or shaft deflections due to its elastic deformability. In addition, the first region may, at least in part, be elastically compressible in order to provide for further additional compensation.

It is particularly preferred that the second region of the outer bearing part comprises an elastically deformable flange. The elastic flange may comprise a hollow-cylindrical region which is connected to the second region and which is substantially concentric with the axis of rotation. The flange may (in addition or alternatively) comprise a region extending, at least in part, in a plane perpendicular to the axis of rotation.

Moreover, the outer bearing part may comprise a third region which is adapted for fastening the outer bearing part to a mounting structure (e.g. a housing of the bearing arrangement). The third region is preferably connected to the second region (e.g. a flange) and may comprise a hollow-cylindrical region which is substantially concentric with the axis of rotation.

In addition, the outer bearing part may comprise a fourth region which is adapted for operative connection with a region of the end of the shaft.

The present invention further provides an arrangement comprising a shaft having an end and a bearing arrangement according to the invention, wherein the end of the shaft and the inner bearing part are coupled to each other in a torsion-resistant manner.

The end of the shaft preferably comprises at least one lubricating bore via which, for example, one or a plurality of load-free zones of the inner bearing part may be supplied with a lubricant.

Furthermore, the present invention provides an oscillator comprising the above arrangement according to the invention, wherein at least one unbalanced mass may be provided which may be rotated by means of the shaft.

### BRIEF DESCRIPTION OF THE DRAWINGS

In the following, preferred embodiments of the present invention are described with reference to the attached drawings, in which:

FIG. 1 shows a schematic sectional view of an embodiment of the present invention comprising an elastically deformable inner bearing part; and

FIG. 2 shows a schematic sectional view of an embodiment of the present invention comprising an elastically deformable outer bearing part.

### DESCRIPTION OF PREFERRED EMBODIMENTS

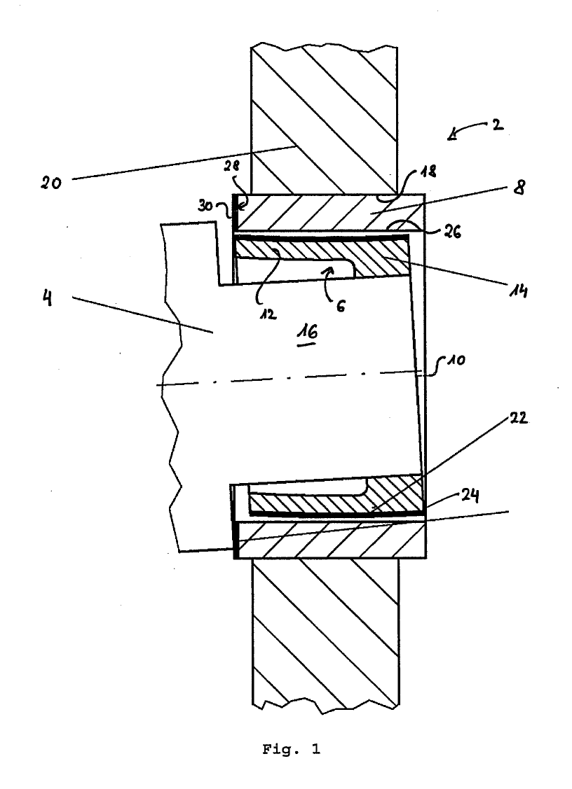

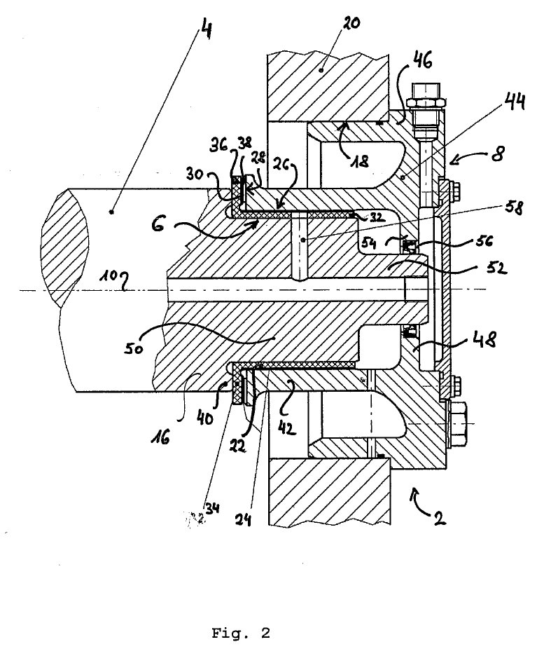

FIGS. 1 and 2 show preferred embodiments of the present invention which are used, for example, in an oscillator or vibrator or which may be a component thereof. An example of an oscillator or vibrator is described, for example, in WO 2005/075749 A1. In the following, it is referred to an application of the present invention in an oscillator for the sake of illustration; however, as already explained above, application of the present invention is not limited to devices of this kind, rather it is contemplated wherever rotational shaft deformations and/or shaft deflections are to be compensated.

Oscillators and vibrators generate oscillations and/or vibrations by means of one or a plurality of unbalanced masses arranged on one or a plurality of shafts, which oscillations and/or vibrations are transmitted, for example, to piling material (e.g. piles, beams etc.) to be inserted into the soil.

By rotation of the unbalanced mass(es), forces, in particular, centrifugal forces, acting on the bearings of the shaft(s) occur. Moreover, the bearings are subject to high rotational speeds. Since the allowable speed of bearings, in particular, roller bearings, decreases with increasing load rating, the load limits of customary bearings (e.g. roller bearings) are restrictive. The use of plain bearings, as described e.g. in WO 2005/075749 A1, constitutes an improvement over roller bearings.

As explained at the beginning, the shaft of an oscillator is deformed (deflected) during operation due to forces generated by rotation of one or a plurality of unbalanced masses. The deformation/deflection of the shaft may cause the mounted shaft ends to become wedged in their bearings and may cause edge pressure in the to bearings (e.g. plain bearings). This may happen, in particular, with increasing rotational speed and/or a greater unbalance mass, since the deformation or deflection then increases as well. The risk of edge pressure in the bearing increases if—as is common practice—greater bearing widths are used for avoiding (high) bearing friction.

Wedging of the shaft ends in their bearings could be limited, in theory, by increasing the bearing clearance and/or using smaller bearing widths. However, a greater bearing clearance may entail the occurrence of an increased surface pressure in the bearing and a jamming of the bearing. A narrow bearing must be designed with a greater diameter for not exceeding the maximum allowable surface pressure in the bearing, which may, inter alia, result in a greater bearing clearance having the said disadvantages. Such approaches are thus inadequate.

According to the invention, this problem is solved by compensating rotational shaft deformations and/or shaft deflections occurring in rotatable shafts by means of a bearing arrangement provided for mounting a shaft end which is, in part, elastically deformable such that wedging of the shaft end in the bearing arrangement is avoided or at least reduced to an acceptable degree.

FIG. 1 shows an embodiment of a bearing arrangement 2 according to the invention intended for mounting a shaft 4.

The bearing arrangement 2 comprises an inner bearing part 6 and an outer bearing part 8 and has an axis of rotation 10.

The inner bearing part 6 has the form of a bearing sleeve for mounting by plain bearing and comprises a first region 12 and a second region 14. The first region 12 has the form of a “detached” hollow cylinder having an inner diameter preventing contact with the shaft 4. The second region 14 also has the form of a hollow cylinder, however, having an inner diameter which is smaller than that of the first region 12 and which is sized such that a torsion-resistant connection may be established with the end 16 of the shaft 4 (e.g. by means of a press fit).

The outer bearing part 8 has the form of a bearing bush for mounting by plain bearing and comprises a mounting surface 18 at its outer circumference. By means of the mounting surface 18, the outer bearing part 8 may be fastened to a mounting structure 20, for example, a part of a housing of the shaft-bearing arrangement. In such embodiments, elastic deformability of the outer bearing part 8 may be dispensed with, if applicable. Alternatively, an outer bearing part may be used which is elastically compressible or comparable to the outer bearing part explained with reference to FIG. 2.

At its outer circumference, the inner bearing part 6 comprises a bearing surface 22 for operative connection with the outer bearing part 8. The bearing surface 22 may be coated, at least in part, with a friction-reducing coating or plain bearing material 24 and/or may be composed, at least in part, of such a material.

According to the illustration, the bearing surface 22 of the inner bearing part 6 has the form of a cylindrical surface area being concentric with the axis of rotation 10.

Advantageously, the outer bearing part 8 (also) comprises a bearing surface 26 provided for operative connection with the inner bearing part 6. The bearing surface 26 may also be coated, at least in part, with a friction-reducing coating or a plain bearing material (not shown) and/or may be composed, at least in part, of such a material.

According to the illustration, the bearing surface 26 of the outer bearing part 8 has the form of a cylindrical surface area being concentric with the axis of rotation 10.

It may further be advantageous if the outer bearing part 8 comprises a further bearing surface 28. In the shown embodiment, said further bearing surface has the form of a front face extending substantially perpendicular to the axis of rotation, which front face faces the shaft 4. The further bearing surface 28 is preferably, at least in part, also provided with a friction-reducing coating or plain bearing material 30 and/or is composed, at least in part, of such a material. Thereby, damages to the shaft 4 and/or the outer bearing part 8 may be avoided or at least reduced, in case shaft deflections occur—as indicated at the bottom of FIG. 1—in which the shaft 4 contacts the outer bearing part 8.

The mode of operation of the embodiments described with reference to FIG. 1 is as follows:

If rotational shaft deformations and/or shaft deflections occur upon rotation of the shaft 4 and rotational inclinations of the shaft end arise as a result thereof, the first region 12 having the form of a “detached” hollow cylinder may be elastically deformed. Thereby, rotational inclinations of the shaft end are compensated rotationally, i.e. the deformation of the first region 12 illustrated in FIG. 1 rotates with the rotating shaft 4 at shaft speed.

FIG. 2 shows a further embodiment of a bearing arrangement 2 according to the invention intended for mounting a shaft 4. The bearing arrangement 2 again comprises an inner bearing part 6 and an outer bearing part 8.

Also in this case, the inner bearing part 6 has the form of a bearing sleeve for mounting by plain bearing. The inner bearing part 6 comprises a hollow-cylindrical region 32 which is connected to the shaft 4 in a torsion-resistant manner, e.g. by means of a press fit, adhesive connection or such like. In such embodiments, elastic deformability of the inner bearing part 6, in particular, in its region 32, may be dispensed with, if applicable. Alternatively, an inner bearing part may be used, which is elastically compressible, in particular, in region 32, or which is comparable to the inner bearing part explained with reference to FIG. 1.

At the outer circumference of its region 32, the inner bearing part 6 comprises a bearing surface 22 for operative connection with the outer bearing part. The bearing surface 22 may be coated, at least in part, with a friction-reducing coating or plain bearing material 24 and/or may be composed, at least in part, of such a material.

According to the illustration, the bearing surface 24 has the form of a cylindrical surface area being concentric with the axis of rotation 10.

The inner bearing part 6 further comprises a region 34 extending substantially perpendicular from the region 32, which region 34 also extends perpendicular to the axis of rotation 10. The flange-like region 34 is provided, at least in part, with a friction-reducing coating or plain bearing material 38 and/or is composed, at least in part, of such a material, at is front face 36 facing the outer bearing part 8 and serving as a bearing surface. At its front face facing the shaft 4, the region 34 is adapted for being supported on a shoulder 40 of the shaft 4.

On the one hand, the region 34 provides for an improved connection with the shaft 4 and, on the other hand, the region 34 provides for a further mounting by plain bearing to the outer bearing part 8.

The outer bearing part 8 comprises a first region 42 which is adapted for operative connection with the inner bearing part 6 and, in particular, with its region 32. The first region 42 is hollow cylindrical and comprises a bearing surface 26 at its inner surface provided for operative connection with the inner bearing part 6. The bearing surface 26 may be coated, at least in part, with a friction-reducing coating or plain bearing material (not shown) and/or may be composed, at least in part, of such a material.

According to the illustration, the bearing surface 26 of the outer bearing part 8 has the form of a cylindrical surface area being concentric with the axis of rotation 10.

Furthermore, the outer bearing part 8 comprises a further bearing surface 28. In the shown embodiment, said further bearing surface has the form of a front face extending substantially perpendicular to the axis of rotation, which front face faces the bearing surface 36 of the inner bearing part 6. The further bearing surface 28 is preferably, at least in part, also provided with a friction-reducing coating or a plain bearing material 30 and/or is composed, at least in part, of such a material. The bearing surface 28 may have the form shown in FIG. 1 or may be arranged, as illustrated in FIG. 2, at a thickened end of the outer bearing part 8 having a greater outer diameter than the region 42.

The outer bearing part 8 further comprises a second region 44 merging into the first region 42 on the right hand side according to the illustration. The second region 44 is elastically deformable and has the form of, for example, a flange.

A third region 46 of the outer bearing part 8 is intended for fastening to a mounting structure 20, for example, a part of a housing of the shaft-bearing arrangement, and comprises a mounting surface 18 for this purpose.

A fourth region 48 of the outer bearing part 8 extends substantially perpendicular to the axis of rotation 10 in form of an annular structure and is adapted for operative connection with the shaft 4. The shaft 4 may be stepped at its end, as shown in FIG. 2 (with regard to its shaft cross-section in the longitudinal direction), for forming the shoulder 40 which provides for a reduction in cross-section towards a first shaft end region 50. The first shaft end region 50 is provided for operative connection with the region 32 of the inner bearing part 6. The shaft may further comprise a second shaft end region 52 having a further reduced diameter. The second shaft end region 52 is provided for operative connection with the fourth region 48 of the outer bearing part 8. For reduction of friction and/or mounting of the second shaft end region 52 and the fourth region 48, the latter may comprise a bearing 56 (e.g. a roller or plain bearing) at its radially inward end 54. Alternatively, a bearing may be disposed at the second shaft end region 52 instead of the fourth region 48. It is further possible that the shaft 4 does not comprise the second shaft end region 52 and that the first shaft end region 50 extends beyond the inner bearing part 6 in the direction towards the shaft end and is provided for operative connection with the fourth region 48 of the outer is bearing part 8.

A lubricant (e.g. oil) may be supplied to the bearing surfaces of the inner and outer bearing parts 6 and 8 via one or a plurality of lubricating bores 58 formed in the shaft 4.

The mode of operation of the embodiments described with reference to FIG. 2 is as follows:

If rotational shaft deformations and/or shaft deflections occur upon rotation of the shaft 4 and rotational inclinations of the shaft end arise as a result thereof, the flange-like second region 44 may be elastically deformed. Thereby, rotational inclinations of the shaft end are compensated rotationally, i.e. the deformation of the second region 44 rotates with the rotating shaft at shaft speed.

In embodiments, in which the inner and/or outer bearing parts 6 and 8, respectively, comprise, at least in part, an elastically compressible material, rotational inclinations of the shaft end due to rotational shaft deformations and/or shaft deflections of the shaft 4 upon rotation thereof are compensated by means of a corresponding compression of the inner and/or outer bearing parts 6 and 8, respectively. In this connection, compensation is also effected rotationally, i.e. the compression rotates with the rotating shaft at shaft speed.

1-30. (canceled)

31. A bearing arrangement for a rotatable shaft comprising:
an inner bearing part for coupling to an end of the shaft,
an outer bearing part for coupling to a mounting structure, and
an axis of rotation,
wherein at least one of the inner bearing part and the outer bearing part, at least in certain areas, possesses elastic deformability, at least in part, perpendicular to the axis of rotation, and wherein the sliding surface of the bearing arrangement is located between the inner bearing part and the outer bearing part.

32. The bearing arrangement according to claim 31, wherein the inner bearing part comprises a bearing sleeve for a plain bearing.

33. The bearing arrangement according to claim 31, wherein the outer bearing part comprises a bearing bush for a plain bearing.

34. The bearing arrangement according to claim 31, wherein the inner bearing part comprises a region which is adapted for torsion-resistant operative connection and, in particular, for positive reception of the end of the shaft.

35. The bearing arrangement according to claim 31, wherein at least one of the inner bearing part and the outer bearing part is, at least in part, elastically compressible.

36. The bearing arrangement according to claim 31, wherein the inner bearing part comprises a first region having a first inner diameter and a second region having a second inner diameter, wherein the first inner diameter is greater than the second inner diameter.

37. The bearing arrangement according to claim 36, wherein the first region of the inner bearing part has the form of an elastically deformable hollow cylinder.

38. The bearing arrangement according to claim 31, wherein the inner bearing part comprises at least one bearing surface for operative connection with the outer bearing part.

39. The bearing arrangement according to claim 38, wherein the at least one bearing surface of the inner bearing part is coated, at least in part, with a plain bearing material and/or is composed, at least in part, of such a material.

40. The bearing arrangement according to claim 38, wherein the at least one bearing surface of the inner bearing part is arranged substantially concentrically with the axis of rotation.

41. The bearing arrangement according to claim 40, wherein the at least one bearing surface of the inner bearing part is formed at an outer circumferential surface being concentric with the axis of rotation.

42. The bearing according to claim 38, wherein the at least one bearing surface of the inner bearing part is arranged substantially perpendicular to the axis of rotation.

43. The bearing arrangement according to claim 42, wherein the at least one bearing surface of the inner bearing part is formed at a region extending substantially perpendicular to the axis of rotation.

44. The bearing arrangement according to claim 43, wherein the region of the inner bearing part extending substantially perpendicular to the axis of rotation is adapted for operative connection with a shoulder formed on the shaft.

45. The bearing arrangement according to claim 31, wherein the outer bearing part comprises at least one bearing surface for operative connection with the inner bearing part and/or the shaft.

46. The bearing arrangement according to claim 45, wherein the at least one bearing surface of the outer bearing part is coated, at least in part, with a plain bearing material and/or is composed, at least in part, of such a material.

47. The bearing arrangement according to claim 45, wherein the at least one bearing surface of the outer bearing part is arranged substantially concentrically with the axis of rotation.

48. The bearing arrangement according to claim 47, wherein the at least one bearing surface of the outer bearing part is formed at an inner circumferential surface being concentric with the axis of rotation.

49. The bearing arrangement according to claim 45, wherein the at least one bearing surface of the outer bearing part is arranged substantially perpendicular to the axis of rotation.

50. The bearing arrangement according to claim 49, wherein the at least one bearing surface of the outer bearing part is formed at a region extending substantially perpendicular to the axis of rotation.

51. The bearing arrangement according to claim 50, wherein the inner bearing part comprises at least one bearing surface formed at a region extending substantially perpendicular to the axis of rotation, and wherein the region of the outer bearing part extending substantially perpendicular to the axis of rotation is adapted for operative connection with the region of the inner bearing part extending substantially perpendicular to the axis of rotation.

52. The bearing arrangement according to claim 31, wherein the outer bearing part comprises a region having a bearing surface for operative connection with the inner bearing part and a mounting surface which is adapted for fastening the outer bearing part to a mounting structure.

53. The bearing arrangement according to claim 31, wherein the outer bearing part comprises a first region for operative connection with the inner bearing part and an elastically deformable second region coupled to the first region.

54. The bearing arrangement according to claim 53, wherein the second region of the outer bearing part comprises an elastically deformable flange.

55. The bearing arrangement according to claim 53, wherein the outer bearing part comprises a third region which is adapted for fastening the outer bearing part to a mounting structure.

56. The bearing arrangement according to claim 53, wherein the outer bearing part comprises a fourth region adapted for operative connection with a region of the end of the shaft.

57. An arrangement comprising:
a shaft having an end, and
a bearing arrangement according to claim 31,
wherein the end of the shaft and the inner bearing part are coupled to each other in a torsion-resistant manner.

58. The arrangement according to claim 57, wherein the end of the shaft comprises at least one lubricating bore.

59. An oscillator comprising the arrangement according to claim 57.

60. The oscillator according to claim 59 comprising at least one unbalanced mass which may be rotated by means of the shaft.
